(19) United States
(12) Patent Application Publication
(10) Pub. No.: US 2007/0079085 A1
(43) Pub. Date: Apr. 5, 2007

(54) Apparatus for storing memory words

(76) Inventor: Hermann Ruckerbauer, Moos (DE)

Correspondence Address: SLATER & MATSIL LLP, 17950 PRESTON ROAD, SUITE 1000, DALLAS, TX, 75252, US

(21) Appl. No.: 11/541,444

(22) Filed: Sep. 29, 2006

(30) Foreign Application Priority Data
Sep. 30, 2005 (DE) 10 2005 046 997.3

(51) Int. Cl. G06F 12/00

(52) U.S. Cl. 711/158

(57) ABSTRACT

An apparatus for storing memory words with a plurality of memory element stacks is described, wherein the memory element stacks have a plurality of memory elements of ascending ranking order, and wherein a memory element of higher ranking order can be accessed via one or a plurality of memory elements of lower ranking order, wherein the apparatus for storing memory words further has a means for distributed storage of a memory word on the plurality of memory element stacks, wherein a memory word is stored in at least two memory element stacks in memory elements of different ranking order.

This application claims priority from German Patent Application No. 10 2005 046 997.3, which was filed on Sep. 30, 2005 and is incorporated herein by reference in its entirety.

### TECHNICAL FIELD

The present invention relates to an apparatus for storing memory words.

### BACKGROUND

It is the object of future memory technologies and memory standards, such as DDR III (DDR=double data rate), to increase the storage density. An undisclosed approach to obtain the storage density for these future memory standards is to equip the DRAMs (DRAM=dynamic random access memory) with a re-drive functionality, i.e., the DRAM can send the data that it obtains from the controller to a next DRAM. This can be performed, for example, by a driver associated to the DRAM, via, which the data are either passed on “internally,” i.e., to the respective DRAM, or via which the data are passed on “externally,” i.e., to a next DRAM. At speeds or data transmission rates of up to 6.4 Gb/s, the power consumption of IO interfaces (IO=input/output) is the dominating part of the consumed power. So far, with DDR technologies of the first and second generation (DDRI, DDRII) without re-drive functionality, the power consumption of the memory core is dominating. Thus, the power consumption is significantly increased by the re-drive functionality.

If a module is built of four quadruply stacked devices with re-drive functionality, and if a write operation to the upper device or rank, respectively, is to be performed, the devices below have to activate their inputs/outputs or IO-interfaces, respectively, i.e., the same require a lot of energy or generate thermal energy, respectively.

In the worst case, the upper devices of the fourfold stacked devices are not only accessed once, i.e., for example, read or written to, but the same are continuously accessed permanently or via a longer period, respectively. This can result in heating, and in the worst case overheating and thus damage of individual devices or the whole module, respectively.

Cooling a quadruple device for the worst case can only be obtained with a lot of effort, for example, via an active cooler or a heat conductive package, and with high cost. If cooling in the worst case is not possible, an “emergency brake,” e.g., a reduction of the access rate, has to be built in.

FIG. 5 shows a block diagram of a possible memory module with a controller 510, a system bus 520 for the transmission of control signals, address data or useful data, as well as four stacks 530, 540, 550 and 560, wherein each of the stacks 530, 540, 550 and 560 has four devices or chips. The devices or chips are numbered in ascending order starting from the system bus 520, e.g. for stack 530, 530-1 to 530-4.

If data are to be written on the upper chip 530-4 of the stack 530, these data are transmitted, for example, from the system bus 520 to the first or lowest chip 530-1, which passes the data onto the next higher chip 530-2, the same passes them on to the next higher chip 530-3, which finally passes the same on to the fourth or upper chip 530-4, respectively, where these data are then written into the chip. In a similar way, for example when reading, the data to be read are transmitted via the chain 530-4 to 530-3 to 530-2 and 530-1 and then to the bus 520.

When storing data words, i.e., data represented by more than one bit, the data words can be split and written in parallel to different memory devices and read from the same again in parallel. Exemplarily, in FIG. 5, a memory word SW1 is shown, which is divided into four parts SW1-1, SW1-2, SW1-3 and SW1-4, wherein the memory word part SW1-1 is stored in the upper chip 530-4 of the rank 530, the memory word part SW1-2 is stored in the upper chip 530-4 of the stack 540, the memory word part SW1-3 is stored in the upper chip 550-4 of the stack 550, and the memory word part SW1-4 is stored in the upper chip 560-4 of the stack 560. The smallest unit or length, respectively, of one part of a memory element is one bit.

Normally, the chips of one rank are accessed, written to or read from as often as the chips of another rank. However, in the above described worst case, data or memory words, respectively, similar to the memory word SW1 are written into the upper chips or read from the upper chips, respectively, over a longer period. This can, as illustrated above, cause overheating and damage of the chips or the memory module, respectively.

In normal operation, i.e., all four ranks are used equally or with the same frequency, the worst case situation will not occur. Only in certain cases, one rank will be written to continuously. In order to intercept this special case or to avoid possible damages of the module, respectively, the integration of extended functions, for example clock throttling in the case of overheating, is possible.

FDIMM (fully buffered dual inline memory module) with a separate re-drive chip, which then obtains local cooling, are, for example, an alternative solution.

In summary, it can be said that the prior art teaches expensive solutions, for example cooling or clock throttling, or even power reducing solutions, for example clock throttling.

### SUMMARY OF THE INVENTION

In one aspect, the present invention provides an efficient concept for reducing the power consumption or for reducing the maximum power consumption, respectively, and the accompanying overheating of a memory or memory module.

In accordance with a first aspect, the present invention provides an apparatus for storing memory words, having: a plurality of memory element stacks; wherein the memory element stacks have a plurality of memory elements of ascending ranking order, and wherein a memory element of higher ranking order can be accessed via one or a plurality of memory elements of lower ranking order; a means for distributed storage of a memory word in the plurality of memory element stacks; wherein a memory word is stored in at least two memory element stacks in memory elements of different ranking order.

In accordance with a second aspect, the present invention provides a method for storing memory words via a number of memory element stacks, wherein the memory element stacks have a plurality of memory elements of ascending ranking order, and wherein a memory element of higher ranking order can be accessed via one or a plurality of memory elements of lower ranking order, having the steps of: distributedly storing a memory word in the plurality of memory element stacks, wherein a memory word is stored in at least two memory element stacks in memory elements of different ranking order.

In accordance with a third aspect, the present invention provides a computer program with a program code for performing the above-mentioned method when the computer program runs on a computer.

Embodiments of the present invention are based on the knowledge that by a clever distribution of the ranks or memory elements, respectively, in a stack device, which will also be referred to as memory element stack below, the maximally consumed power of an apparatus for storing, for example, a DIMM, can be kept on a minimum level. This level corresponds to an average value, which is achieved when it is assumed that all devices or memory elements, respectively, in one memory element stack are addressed for the same proportion of the time, for example a quarter of the time in a memory element stack consisting of four memory elements. Thus, according to embodiments of the invention, an apparatus for storing memory words is provided, which has a plurality of memory element stacks, wherein the memory element stacks have a plurality of memory elements of ascending ranking order, and wherein a memory element of higher ranking order can be accessed via one or a plurality of memory elements of lower ranking order, and which has a means for distributed storage of a memory word on the plurality of memory element stacks, wherein a memory word is stored in at least two memory element stacks in memory elements of different ranking order.

In a preferred embodiment of an inventive apparatus for storing memory words, the memory word is stored in all memory element stacks in memory elements of different ranks, as will be discussed below in more detail with regard to FIG. 1 and FIG. 4.

In a further preferred embodiment of an inventive apparatus for storing memory words, the number of memory elements per memory element stack is equal to a number of memory element stacks of the apparatus, so that for the preferred case, that a memory word is stored in all memory element stacks in memory elements of different ranks, every rank is addressed in a distributed way at every access via the memory element stacks, and thus an optimum reduction of the maximum power consumption is achieved.

In inventive embodiments of the apparatus for storing a memory word, preferably, the means for distributed storage is formed such that one memory word is stored in at least two memory element stacks in memory elements of different ranking order via a memory address conversion. Alternatively, an exemplary apparatus has at least one memory element stack with a memory address converter, which is formed such that the memory word is stored in at least two memory element stacks in memory elements of different ranking order.

Thereby, the address conversion can be performed, for example, via exchanging lines in a memory element stack or stack or by a controller, respectively.

In other words, a differentiation between a physical ranking order and a logic ranking order is introduced, and the link between a logic ranking order and a physical ranking order is effected, for example, by address conversion. Thereby, for example when storing a memory word, the same logic ranking order is still associated to the memory word parts, but the same is converted into a physical ranking order, so that a memory word is no longer only stored in the same physical ranking order in the memory elements. Thereby, the worst case is avoided, or the maximum power consumption is reduced, respectively.

### BRIEF DESCRIPTION OF THE DRAWINGS

These and other objects and features of the present invention will become clear from the following description taken in conjunction with the accompanying drawings, in which:

FIG. 1 is a block diagram of an inventive embodiment of an apparatus for storing a memory word;

FIG. 2 is an exemplary power consumption for an individual memory element stack in a worst case scenario;

FIG. 3 is an exemplary power consumption for an individual memory element stack for a uniform distribution of the accesses to the individual memory elements;

FIG. 4 is an exemplary power consumption of an inventive apparatus for storing with four memory element stacks and four memory elements per memory element stack; and

FIG. 5 is a possible memory module with four stacks and four chips per stack.

### DETAILED DESCRIPTION OF ILLUSTRATIVE EMBODIMENTS

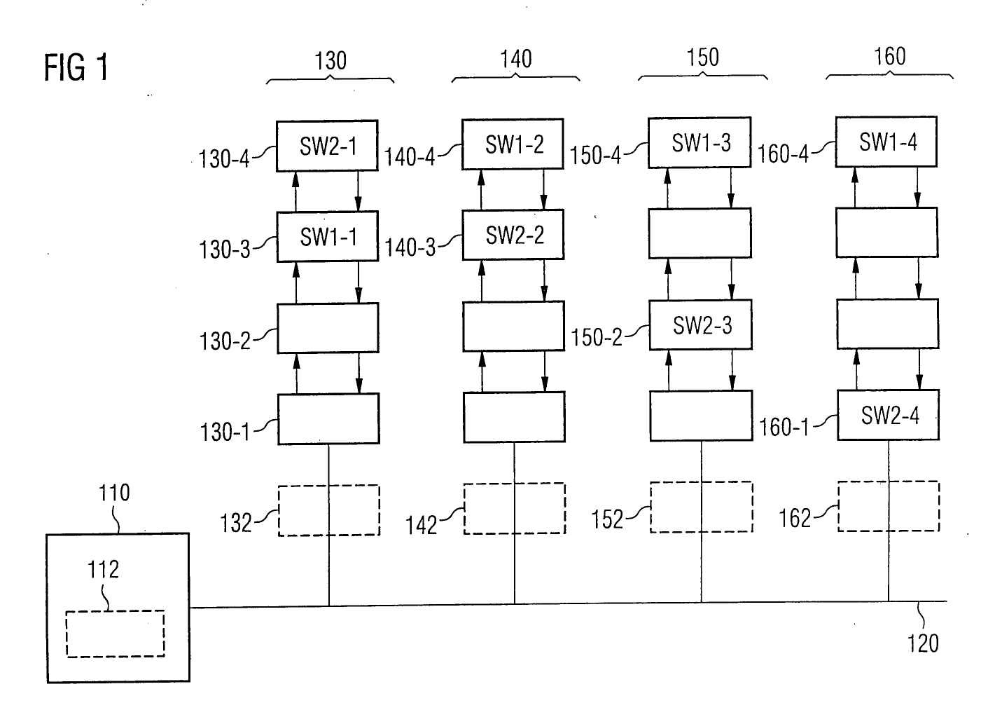

FIG. 1 shows a block diagram of an inventive embodiment of the apparatus for storing memory words, wherein the apparatus for storing comprises a means 110 for distributed storage of the memory word, a bus system 120 and four memory unit stacks, a first memory unit stack 130, a second memory unit stack 140, a third memory unit stack 150 and a fourth memory unit stack 160. Each of the memory unit stacks 130, 140, 150, 160 has again four memory units, wherein the memory elements are disposed in ascending ranking order starting from the bus system 120. Thus, the first memory element stack 130 comprises a first memory element or memory element of first ranking order 130-1, which is connected to the bus 120, a second memory element or memory element of second ranking order 130-2, which is connected to the first memory element 130-1, a third memory element or memory element of third ranking order 130-3, which is connected to the second memory element 130-2, and a fourth memory element or memory element of fourth ranking order, which can be also referred to as upper memory element, 130-4, which is connected to the third memory element 130-3.

If data in general form are to be written to the fourth memory element 130-4 of the first memory element stack 130, then, as described above in FIG. 5, the data are transmitted, for example, from the bus system 120 to the first memory element 130-1, from there to the second memory element 130-2, from there to the third memory element 130-3 and from there to the fourth memory element 130-4.

In an inventive embodiment of the apparatus for storing memory words, the memory word is divided into memory word parts, these memory word parts are not stored in the memory elements of the same ranking order, in contrary to the memory module illustrated in FIG. 5.

One possibility for the distribution to memory elements of different ranking orders is illustrated with regard to the memory word SW1, wherein a first part SW1-1 of the first memory word SW1 is stored in a third memory element 130-3 of the first memory element stack 130, a second part SW1-2 of the first memory word SW1 is stored in a fourth memory element 140-4 of the second memory element stack 140, a third part SW1-3 of the first memory word SW1 is stored in a fourth memory 150-4 of the third memory element stack 150, and a fourth part SW1-4 of the first memory word SW1 is stored in a fourth memory element 160-4 of the fourth memory element stack 160. By the fact that the first part SW1-1 of the first memory word SW1 is not stored in the fourth memory element 130-4 of the first memory element stack 130, but in the third memory element 130-3 of the same memory element stack 130, the power consumption is reduced compared with the worst case, as illustrated in FIG. 5 with regard to the memory word SW. Any other distributions are possible.

An embodiment is illustrated with regard to a memory word SW2, wherein here the memory word SW2 is stored in the memory element stacks 130, 140, 150, 160 in memory elements of different ranking orders. The first part SW2-1 of the second memory word SW2 is stored in the fourth memory element 130-4 of the first memory element stack 130, the second part SW2-2 of the second memory word SW2 is stored in the third memory element 130-3 of the second memory element stack 140, the third part SW2-3 of the second memory word SW2 is stored in the second memory element 150-2 of the third memory element stack 150, and the fourth part SW2-4 of the second memory word SW2 is stored in the first memory element 160-1 of the fourth memory element stack 160. If all memory words with regard to the memory stacks 130, 140, 150, 160 are stored in memory elements of different ranking order, a minimization of the maximum possible power consumption is achieved.

The inventive method can be explained, for example, by the introduction of an additional logic ranking order compared to the “physical” ranking order. The physical or spatial arrangement, respectively, of the individual memory elements within a memory element stack and thus their basic connection can remain unchanged, however, the distribution of a memory word or the addressing of the individual memory elements, respectively, varies in comparison with the memory elements of another memory element stack, where a uniform logic ranking order is associated to a memory word for the individual memory element stacks, but different physical ranking orders for the individual memory element stacks. Thereby, a memory word is stored in memory elements of different physical ranking order in the memory element stacks. This can be realized, for example, by address conversion between the logic ranking order and the physical ranking order, wherein the logic ranking order can also be considered as “logic” address or logic address part, respectively, and the physical ranking order as “physical” address or physical address part, respectively.

An exemplary address conversion between a logic ranking order and a physical ranking order is discussed in more detail with reference to FIG. 1. Thereby, for example, for addressing one of the four memory elements of memory element stacks, a two-bit address word can be used, for example “00” for the first memory element, “0” for the second memory element, “10” for the third memory element, and “11” for the fourth or upper memory element, respectively.

In the conventional art, a memory word would be divided into four memory word parts, wherein a controller 510 would address the four different memory word parts with the same memory element address, or would write into the same physical memory elements, respectively, which can lead to the above-described worst case.

In the embodiment shown in FIG. 1 with regard to the memory word SW2, for example, the same logic ranking order “11” is associated to the memory word or the four memory word parts SW2-1 to SW2-4, respectively, however, prior to the physical access, a physical ranking order is associated to the logic ranking order, which is different for the individual memory element stacks 130, 140, 150, 160. Thus, for example for the memory element stack 130, the physical ranking order corresponds to the logic ranking order “11,” which is why the first part SW2-1 of the second memory word SW2 is stored in the fourth memory element 130-4 of the memory element stack 130, for the second memory element stack 140, the physical ranking order or address “10” is associated to the logic ranking order “11,” which is why the second memory word part SW2-2 is stored in the third memory element 130-4 of the second memory element stack 140, for the third memory element stack 150, the logic ranking order or address “11,” respectively, is converted into the physical ranking order or address “01,” respectively, so that the third memory word part SW2-3 of the second memory word SW2 is stored in the memory element 150-2 of the third memory element stack 150, and for the fourth memory element stack 160, the logic rank or address “11”, respectively, is converted into the logic rank or address “00,” respectively, so that the fourth memory word part SW2-4 of the second memory word SW2 is stored in the first memory element 160-1 of the fourth memory element stack 160.

The memory conversion can be performed, for example, by a central means 112 of memory conversion, or by one or a plurality of means for address conversion 132, 142, 152, 162 in the individual memory element stacks 130, 140, 150, 160, wherein one embodiment of the inventive apparatus for storing memory words can have only one means for address conversion, e.g., the means 132 for address conversion of the first memory element stack 130, or two or three or four, i.e., for all of them, which means a means for address conversion 142 for or in the second memory element stack 140, a means 152 for address conversion for or in the third memory element stack 150, and a means 162 for address conversion for or in the fourth memory element stack 160.

Generally, it is also possible to control this distribution of a memory word on memory elements of different ranking orders, or the address conversion, respectively, by an external unit, however, within the compatibility to other memory devices, such as DDRIII or the usage with other devices, this distribution or address conversion, respectively, is preferably performed within the apparatus for storing, so that this method is not visible for external devices, and the communication with the apparatus for storing by other memories does not have to be changed.

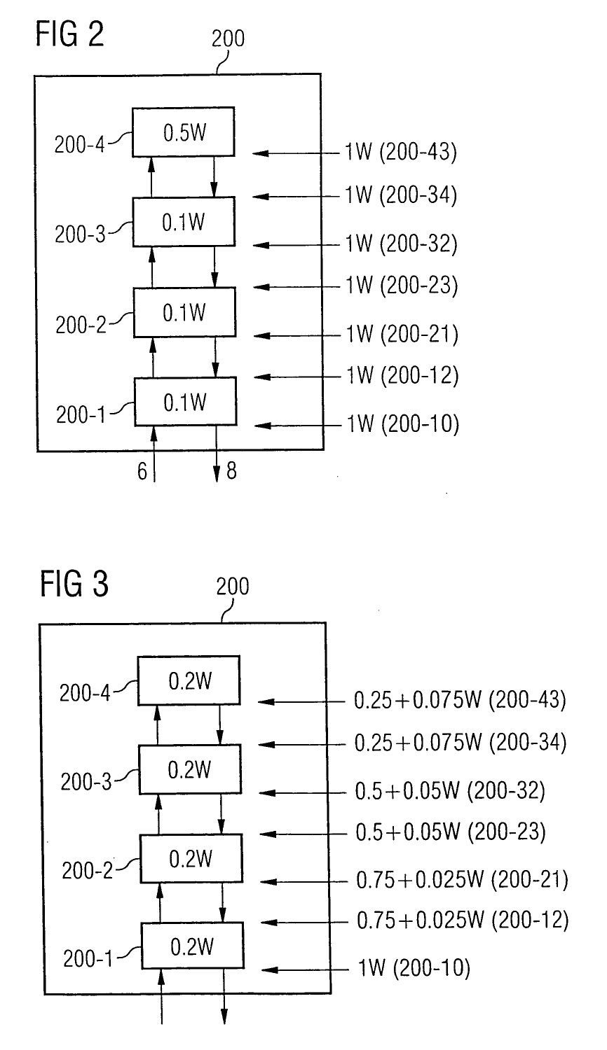

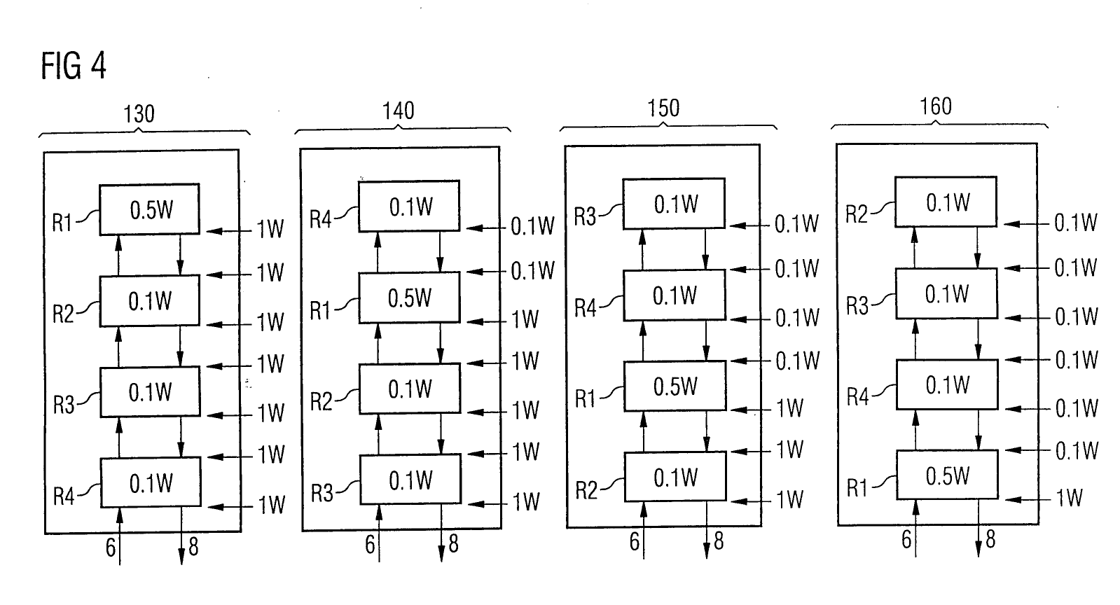

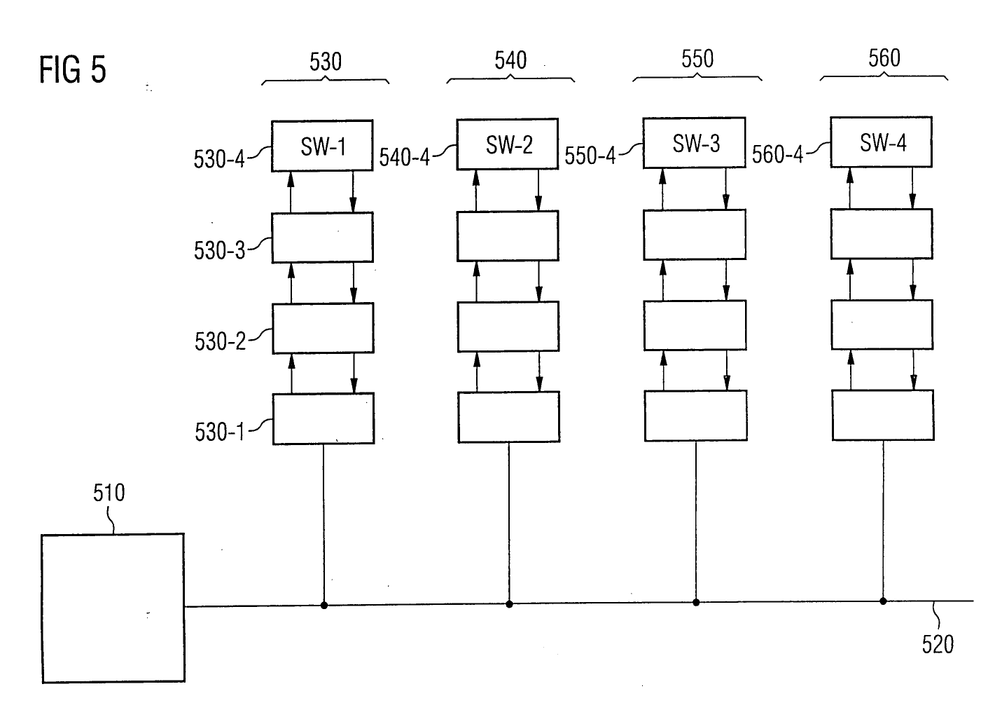

FIG. 2 shows an exemplary individual stack or memory element stack 200 with four DRAM devices or memory elements 200-1, 200-2, 200-3, 200-4 and further shows a worst case power consumption scenario for the same. The interface of the first memory element 200-1, for example, to a bus system, is indicated by 200-10, the interface of the first memory element 200-1 to the second memory element 200-2 is indicated by 200-12, the IO interface of the second device 200-2 to the first memory element 200-1 is indicated by 200-21, wherein the first digit after the hyphen indicates the respective memory element and the second digit after the hyphen the memory element, with which the memory element is connected via this interface. This nomenclature applies for the other interfaces in FIG. 2 as well as for the interfaces in FIGS. 3 and 4.

The values for the power consumption of the memory cores of the individual memory elements are inserted in the blocks of the memory elements. The values for the power consumption of the IO interfaces are each inserted on the right side of the individual memory elements or their interfaces, respectively. This applies for FIGS. 2 to 4.

Worst case means that the upper or fourth memory element, respectively, is always active, i.e. that this memory element is always accessed.

The power consumption of the memory core of the memory element 200-4 is 0.5 W, since it is active. The power consumption of the memory cores of the three memory elements 200-1, 200-2, 200-3, which is also referred to as core power, is only 0.1 W, since the same are inactive. Thus, the whole memory core power consumption is 0.8 W.

Since the upper or fourth memory element 200-4, respectively, is accessed, all IO interfaces are active, wherein every IO interface has an IO power consumption, also referred to as IO power of 1 W, so that the overall IO power consumption of the memory element stack is 7 W.

Thus, an overall power consumption of 7.8 W per memory element stack and a power consumption of 31.2 W for a DIMM module result, which has, for example, four memory element stacks with the above-mentioned power consumption.

FIG. 3 shows the same memory element stack 200 of FIG. 2 with four memory elements 200-1, 200-2, 200-3, 200-4. The interfaces of the individual memory elements are designated according to the above-described nomenclature.

FIG. 3 shows a scenario for a mixed equally distributed access to the four memory elements 200-1, 200-2, 200-3, 200-4, i.e., a quarter of the accesses per memory element or every memory element, respectively, is active for one quarter of the time.

The power consumption of the individual memory elements is calculated from the sum of power consumption in the active state, ¼×0.5 W=0.125 W, and the power consumption in the inactive time, ¾×0.1 W=0.075 W, so that an overall power consumption per memory element of 0.2 W results, and a memory core power consumption of 0.8 W results for the whole memory element stack 200.

The power consumption of the individual IO interfaces results from the sum of the power consumption in the inactive state and the power consumption in active state, wherein the left of the power consumption values shown in FIG. 3 indicates the power consumption in the active state, and the right value indicates the power consumption in the inactive state.

The IO interface 200-10 is always active, and has thus a power consumption of 1 W. Since all memory elements are accessed equally distributed, the memory interfaces 200-21 and 200-12 are active 75% of the time, so that a power consumption in the active state of 0.75×1 W=0.75 W results, and a power consumption in the inactive state of 0.25×0.1 W=0.025 W results, and thus an overall power consumption of 0.775 W. The interfaces 200-23 and 200-32 are correspondingly active 50% of the time, i.e., a power consumption in the active state of 0.5×1 W=0.5 W results, and in the inactive state of 0.5×0.1 W=0.05 W, and thus an overall power consumption of 0.55 per IO interface. For the interfaces 200-34 and 200-43, which are active only 24% of the time, a power consumption in the active state of 0.25×1 W=0.25 W results, and in the inactive state of 0.75×0.1 W=0.075 W, and thus an overall power consumption of 0.325 W. The overall IO power consumption of the memory element stack 200 is thus 4.3 W.

Thus, the overall power consumption of a memory element stack is 5.1 W, and the one of a DIMM module with, for example, four memory element stacks of the above-mentioned power consumption is 20.4 W.

The power consumption or the peak power consumption, respectively, according to the scenario in FIG. 3, is thus by 10.8 W lower or by 34% reduced in comparison with the power consumption of the scenario according to FIG. 2.

FIG. 4 shows a preferred embodiment as discussed with regard to FIG. 1 and the second memory word SW2, and represents thus the preferred inventive method for avoiding, for example, a worst-case DIMM configuration, as illustrated in FIG. 5 with regard to the memory word SW.

FIG. 4 shows an apparatus for storing a memory word with four memory element stacks 130, 140, 150, 160, which each comprise four memory elements. For the description of FIG. 4, the term rank is used, wherein the rank corresponds to the physical ranking order of FIG. 1, and is introduced in FIG. 4 with regard to the invention as logic rank. Thereby, the first rank R1 corresponds, for example, to the logic ranking order 4 of FIG. 1, the second rank R2 to the third logic ranking order, the third rank R3 to the second logic ranking order, and the fourth rank R4 to the first logic ranking order.

With regard to the embodiment in FIG. 4, the power consumption of the overall apparatus for storing is illustrated, wherein in the illustrated scenario the first rank R1 or the first logic rank, respectively, is active, or with regard to FIG. 1, for example, the second memory word SW2 is read or written, as illustrated in FIG. 1.

Correspondingly, for the first memory element stack 130, the worst case scenario discussed in FIG. 2 results for an individual memory element stack with a power consumption of 7.8 W.

In correspondence to the scenario, the first rank R1 or the memory element of the third physical ranking order, respectively, is active in the second memory element stack 140, so that the IO interfaces between the first rank R1 and the fourth rank R4 are inactive, i.e., only have a power consumption of 0.1 W each, while the other interfaces are active, which means they each have a power consumption of 1 W. The power consumption of the memory cores results from 0.5 W for the active memory core and 0.1 W for the inactive memory cores, so that an overall power consumption of 6 W results for the second memory element stack 140.

According to the scenario, the first rank R1, which here corresponds to the memory element of the second physical ranking order, is active in the third memory element stack 150, so that the third rank R3 and the fourth rank R4 are inactive, so that a power consumption of 0.1 W each results for the interfaces between the first rank R1 and the fourth rank R4 and the third rank R3, which are inactive, and for the other interfaces, which are active, 1 W each. The power consumption of the memory cores is 0.8 W as before, so that an overall power consumption of 4.2 W results for the third memory element stack 150.

Then, the best case results for the fourth memory element stack 160, where only rank 1 or the memory element of the first physical ranking order is active, so that only the interface between rank 1 and, for example, a bus system is active, and thus has a power consumption of 1 W, while other IO interfaces have a power consumption of 0.1 W. The power consumption of the memory cores is 0.8 W as before, so that an overall power consumption of only 2.4 W results for the fourth memory element stack 160.

If the above calculated power values of the individual memory element stacks 130, 140, 150, 160 are added, as expected, an overall power consumption of 20.4 W is obtained for the inventive apparatus for storing (or for an exemplary DIMM module), or an overall memory core power consumption of 3.2 W and an overall IO power consumption of 17.2 W.

The power consumption always results and is independent of which rank is currently active. This shows that by the inventive distribution of ranks or ranking orders of the memory elements within the memory element stacks the occurrence of the worst case is avoided.

With regard to the memory elements, this invention can be applied to any memory technologies. Further, the number of memory elements per memory element stack or the number of memory element stacks per apparatus for storing is not limited.

Thus, embodiments of inventive memories cannot only have four memory element stacks, each with four memory elements, but, for example, also four memory element stacks, each with two memory elements, eight memory element stacks, each with four memory elements, i.e. more memory element stacks than memory elements per memory element stack, or, for example, two memory element stacks, each with four memory elements per memory element stack, i.e. more memory elements per memory element stack than memory element stacks.

An embodiment of an inventive memory with, for example, four memory stack elements, each with two memory elements per memory element stack stores a memory word such that at least one part of the memory word is no longer stored in the upper memory element of a memory element stack, which means, for example a first part of the memory word in a lower memory element of a first memory element stack and the other parts of the memory word in upper memory elements of second, third and fourth memory element stacks. A preferred embodiment of such a memory stores two parts of a four-part memory word in the lower memory elements of two memory element stacks and the two other parts of the memory word in the upper memory elements of the two other memory element stacks, to thereby minimize the maximally possible power consumption.

Generally, preferred embodiments of the invention are formed such that the maximally possible power consumption for every logic ranking order or the respective association of physical ranking orders or combination of memory elements of different memory element stacks is minimized. Preferred address conversions distribute the parts of memory words “in pairs” in memory elements of opposite ranking order, i.e., a first part of a memory word in a memory element of the highest ranking order and a second part of the memory word in a memory element of the lowest ranking order, or in other words, in the upper memory element of a memory element stack and the lower memory element of a further memory element stack. Thereby, this association “in pairs” can comprise adjacent memory element stacks, but can, however also comprise any spatial association of memory element stacks. Correspondingly, preferably, a memory element of the second highest ranking order is combined with a memory element of a second lowest ranking order of another memory element stack, etc.

Thus, in summary, it can be said that the inventive arrangement of ranks within a multi-rank stack device or the clever arrangement of, for example, four memory elements within a memory element stack, results in the fact that the worst case, namely that all four memory element stacks write on the upper chip or the memory element of the highest or fourth ranking order, respectively, cannot occur.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. An apparatus for storing memory words, the apparatus comprising:
a plurality of memory element stacks,
wherein the memory element stacks have a plurality of memory elements of ascending ranking order, and wherein a memory element of higher ranking order can be accessed via one or a plurality of memory elements of lower ranking order; and
a controller for distributed storage of a memory word in the plurality of memory element stacks,
wherein a memory word is stored in at least two memory element stacks in memory elements of different ranking order.

2. The apparatus according to claim 1, wherein a number of memory elements per memory element stack is equal to a number of memory element stacks of the apparatus.

3. The apparatus according to claim 1, wherein the memory word is stored in all memory element stacks in memory elements of different ranking order.

4. The apparatus according to claim 1, wherein the controller for distributed storage is formed such that a memory word is stored in at least two memory stacks in memory elements of different ranking order via memory address conversion.

5. The apparatus according to claim 1, wherein the at least one memory element stack has a memory address converter, which is formed such that the memory word is stored in at least two memory element stacks in memory elements of different ranking order.

6. A method for storing memory words via a number of memory element stacks, wherein the memory element stacks have a plurality of memory elements of ascending ranking order, and wherein a memory element of higher ranking order can be accessed via one or a plurality of memory elements of lower ranking order, the method comprising:
distributedly storing a memory word in the plurality of memory element stacks,
wherein a memory word is stored in at least two memory element stacks in memory elements of different ranking order.

7. The method according to claim 6, wherein a number of memory elements per memory element stack is equal to a number of memory element stacks of the apparatus.

8. The method according to claim 6, wherein the memory word is stored in all memory element stacks in memory elements of different ranking order.

9. The method according to claim 6, wherein the memory word is stored in at least two memory stacks in memory elements of different ranking order via memory address conversion.

10. The method according to claim 6, wherein the at least one memory element stack has a memory address converter, which is formed such that the memory word is stored in at least two memory element stacks in memory elements of different ranking order.

11. A computer program with a program code for performing a method for storing memory words via a number of memory element stacks, wherein the memory element stacks have a plurality of memory elements of ascending ranking order, and wherein a memory element of higher ranking order can be accessed via one or a plurality of memory elements of lower ranking order, the method comprising the steps of:
distributedly storing a memory word in the plurality of memory element stacks,
wherein a memory word is stored in at least two memory element stacks in memory elements of different ranking order,
wherein the computer program runs on a computer.

12. The computer program according to claim 11, wherein a number of memory elements per memory element stack is equal to a number of memory element stacks of the apparatus.

13. The computer program according to claim 11, wherein the memory word is stored in all memory element stacks in memory elements of different ranking order.

14. The computer program according to claim 11, wherein the memory word is stored in at least two memory stacks in memory elements of different ranking order via memory address conversion.

15. The computer program according to claim 11, wherein the at least one memory element stack has a memory address converter, which is formed such that the memory word is stored in at least two memory element stacks in memory elements of different ranking order.
